(19) United States
(12) Patent Application Publication
(10) Pub. No.: US 2019/0362571 A1
(43) Pub. Date: Nov. 28, 2019

(54) Access Control, Resource and Priority Management System and Method

(71) Applicant: The Well Effect Company, Bedford, MA (US)

(72) Inventor: John Jamesapollos, Bedford, MA (US)

(73) Assignee: The Well Effect Company, Bedford, MA (US)

(21) Appl. No.: 15/989,582

(22) Filed: May 25, 2018

(51) Int. Cl. G07C 9/00; G06F 21/31; G06Q 10/06; G06Q 10/02; H04W 12/06

(52) U.S. Cl. CPC G07C 9/00031; G06F 21/31; H04W 12/06; G06Q 10/02; G06Q 10/0631

(57) ABSTRACT

An access control system and method for a building, facility or secured area and designed to maximize the use of the resource before expiration, having an entrance, includes an access control mechanism, a credential reader and a server. The access control mechanism is connected to the entrance and is operable between a locked position and an unlocked position. The credential reader is configured and arranged to read a credential presented by a user. The server is connected to the credential reader and access control and is configured and arranged to authenticate the credential of the user and whether the user had a valid reservation. The server unlocks the access control mechanism if the user has a valid credential and reservation.

### TECHNICAL FIELD

The present patent document relates generally to control entry and manage use of resources within a building, facility, or otherwise secured area, and more particularly to an access control system with an integrated reservation, capacity control and resource priority management system, restricting use to authorized users that have reservation/appointments to access the resource available and to manage the capacity and reserve those resources for their highest and best use as determined by the management/owner of those protected resources within the building, facility, or secured area.

### BACKGROUND

Buildings, facilities or subdivisions thereof that are restricted to only authorized users are desirable for controlling entry to these restricted areas and use of any resources contained therein. However, prior art access control systems generally operate in a binary manner. That is, the user requesting entry is either determined to be authorized to enter the restricted area, and allowed in, or determined to lack the necessary authorization, and refused entry.

### SUMMARY

Therefore, there is a perceived need in the art for a method or system of controlling access to a building, facility, or otherwise secured area, and manage access to the resources contained therein, that does not require the use of a person to authenticate a visitor's authorization to enter. Furthermore, there is a perceived need for a method or system that not only verifies whether a user is authorized, but also whether the user has a valid reason and the facility has sufficient capacity for the user to access the resources contained therein to allow entry of the visitor.

The access control system disclosed herein solves the problem of the prior art by providing a system that not only restricts entry to only authorized users, but also provides additional restrictions in allowing only authorized user with a valid reason to enter at a valid time. Authorized users that attempt to request entry that lack a valid reason or request entry at an unauthorized time are turned away by the system. Additionally, the owner/management can offer the resources contained within the building, facility, or otherwise secured area to be used by the user requesting access to the resources in such a manner that puts the resources to a highest and best use as defined by the management/owner thereby ostensibly maximizing management/owner goals for the use by the user of the resource.

In one embodiment, the system validates that the user has a “Reason” for requesting entry access to the resource at that time, such as, but not limited to, an appointment, a reservation, class participation, or scheduled workout or for any other management-defined “Reason.”

In another embodiment, the system queries a database to determine if the user has an approved and/or scheduled “Reason” for requesting entry and then determine if the user requesting entry is within a particular management-defined “Time Frame” of their “Reason.”

In another embodiment, if the user is within the management-defined “Time Frame” then the user's request is validated. The system may then unlock the door and allow the user to enter the restricted area. If the user is not “Validated” the system can alert the user, the database, or the management to the exception of an attempted unscheduled entry.

In another embodiment, if the user is Validated the system can mark the user's Reason for being there as complete, thus, dunning the user's account and/or preventing reentry.

In another embodiment, the system may dynamically allocate resources to the highest and a best use. Any of these resources have a finite useful shelf life that expires when the time to use them has passed. It is inventory that is reservable up to that point and then is lost after the time has passed. To try and maximize the use of the resources, the system allocates resources dynamically based on management's defined use of the resource for the user's purpose. Dynamic resource allocation allows the system to recognize that some resources (at a highest and best use) may remain unused as they near their expiration, allowing the system to free them up or reallocate them at a management determined time frame prior to expiration to enable a lower use and then alert potential users to the availability of the resource at a lower use for the resource before the resource expires when the time to use it has passed and optimize the next best use and maximize the allocation of capacity of the resource.

### BRIEF DESCRIPTION OF THE DRAWINGS

Various aspects of at least one embodiment are discussed below with reference to the accompanying figures, which are not necessarily drawn to scale, emphasis instead being placed upon illustrating the principles disclosed herein. The figures are included to provide an illustration and a further understanding of the various aspects and embodiments, and are incorporated in and constitute a part of this specification, but are not intended as a definition of the limits of any particular embodiment. The figures, together with the remainder of the specification, serve only to explain principles and operations of the described and claimed aspects and embodiments, but are not to be construed as limiting embodiments. In the figures, each identical or nearly identical component that is illustrated in various figures is represented by a like numeral. For purposes of clarity, not every component may be labeled in every figure.

FIG. 1A is a diagram showing an embodiment of a facility implementing an access control system in accordance herewith;

FIG. 1B is a diagram of a device which may be configured as one or more of a server, credential reader, and/or credential for the access control system in accordance herewith;

FIG. 2 is a flowchart of an embodiment of an entry system process for an access control system in accordance herewith;

FIG. 3 is a flowchart of an embodiment of a user setup process for an access control system in accordance herewith;

FIG. 4 is a flowchart of an embodiment of a reservation setup process for an access control system in accordance herewith;

FIG. 5A is a first portion of a flowchart of an embodiment of a reservation request process for an access control system in accordance herewith;

FIG. 5B is a second portion of the flowchart illustrated in FIG. 5A;

FIG. 6 is a flowchart of an embodiment of a reservation reminder process for an access control system in accordance herewith;

FIG. 7 is a flowchart of an embodiment of a waitlist process for an access control system in accordance herewith;

FIG. 8 is a flowchart of an embodiment of a cancellation request for an access control system in accordance herewith; and

FIG. 9 is a flowchart of an embodiment of an exemplary resource listing display for an access control system in accordance herewith.

### DETAILED DESCRIPTION OF THE ILLUSTRATIVE EMBODIMENTS

The examples of the methods and systems discussed herein are not limited in application to the details of construction and the arrangement of components set forth in the following description or illustrated in the accompanying drawings. It will be understood to one of skill in the art that the methods and systems are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

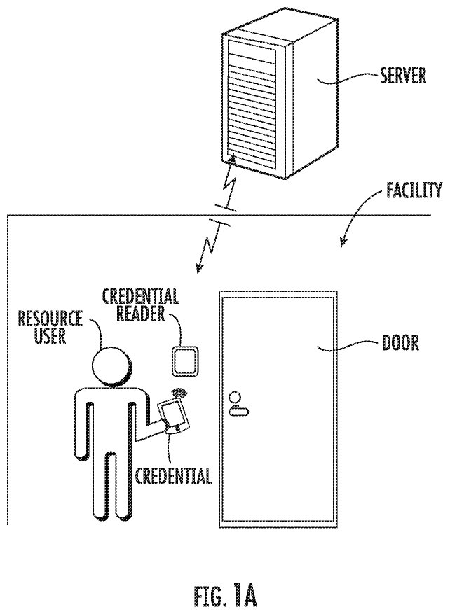

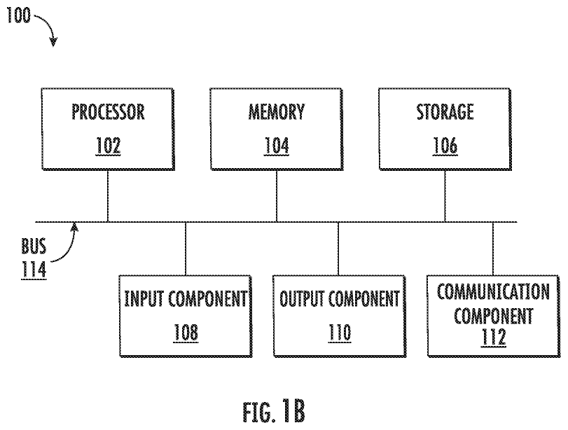

FIG. 1A is a diagram showing an embodiment of a facility implementing an access control system, shown generally at 10. The access control system includes a server 12, a credential reader 14 communicatingly connected to the server 12, and an entrance 16 to the building, facility, or other secured area 23, having an access control mechanism 18, such as a lock, controlled by the server 12 and/or credential reader 14. The entrance 16 may be a door, gate, turnstile, revolving door, elevator, escalator, and the like. The access control mechanism 18 is connected to the entrance 16 and is operable between a locked position and an unlocked position. The credential reader 16 is configured and arranged to read a credential 20 presented by a user 22. The server 12 is configured and arranged to authenticate the credential 20 of the user 22 and whether the user 22 had a valid reservation within a management/owner pre-configured time window of the reservation. The server 12 unlocks, or sends a signal to the credential reader 14 and/or access control mechanism 18 to unlock, as the case may be, the access control mechanism 18 to the entrance 16 if the user 22 has a valid credential 20 and reservation that is within the pre-configured time window of the reservation.

The term “server” can include a hardware server, a virtual machine, a software server, or a combination thereof. Furthermore, the functionality described for the server 12 may be divided between one or more servers. The server 12 may be located on site at the building, facility, or secured area 24, or may be located offsite. The server 12 may have one or more devices 100 illustrated in FIG. 1B and described below.

The credential reader 14 is configured and arranged to read a credential 20 of a user 22 for subsequent verification of whether a user 22 is authorized and allowed into the building, facility, or secured area 24. The credential reader may include a contactless method, card reader, a numerical pin pad, and/or a biometric reading device. For instance, near-field communications (“NFC”) may be used with an NFC-enabled device, such as a smartphone. Alternatively, an application on a smartphone configured to communicate with the credential reader 14 via a wireless communication protocol, such as Bluetooth, wi-fi, cellular, Z-Wave, Zigbee, and the like, may be used. Key fob access systems may be used, which typically communicate in 125 kHz or 13.56 MHz bands. The credential reader 14 may also use radio frequency identification (“RFID”) to uniquely identify a credential possessed by a user 22 or visitor. The credential reader 14 may include a device 100 as shown in FIG. 1B and described further below.

The access control mechanism 18 may be controlled directly by the server 12 or indirectly via the credential reader 14. The access control mechanism 18 may include a remotely controlled deadbolt or latch. In some embodiments, the access control mechanism 18 includes a device 100 as shown in FIG. 1B and described further below.

FIG. 1B is a diagram of example components of a device 100 which may be configured for or included in the server 12, user credential 20, credential reader 14, or access control mechanism 18, described above, or a user device configured to interact with the server 12 via a wired or wireless communication protocol. The device 100 may include one or more of a processor 102, a memory 104, a storage 106, an input component 108, an output component 110, a communication component 112, all interconnected via a system bus 114. Bus 114 may include a component that permits communication among the components of device 100. Processor 102 is implemented in hardware, firmware, or a combination of hardware and software. Processor 102 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 104 may include a random access memory (RAM), a read only memory (ROM), and/or another type of dynamic or static storage device (e.g., a flash memory, a magnetic memory, an optical memory, etc.) that stores information and/or instructions for use by processor 320.

Storage 106 may store information and/or software related to the operation and use of device 100. For example, storage 106 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive. The storage may be solid state or a hard disk drive. Furthermore, the storage may be organized into a database. The database may have a relational or non-relational architecture. In some embodiments, the storage 106 and memory 104 are integrally combined.

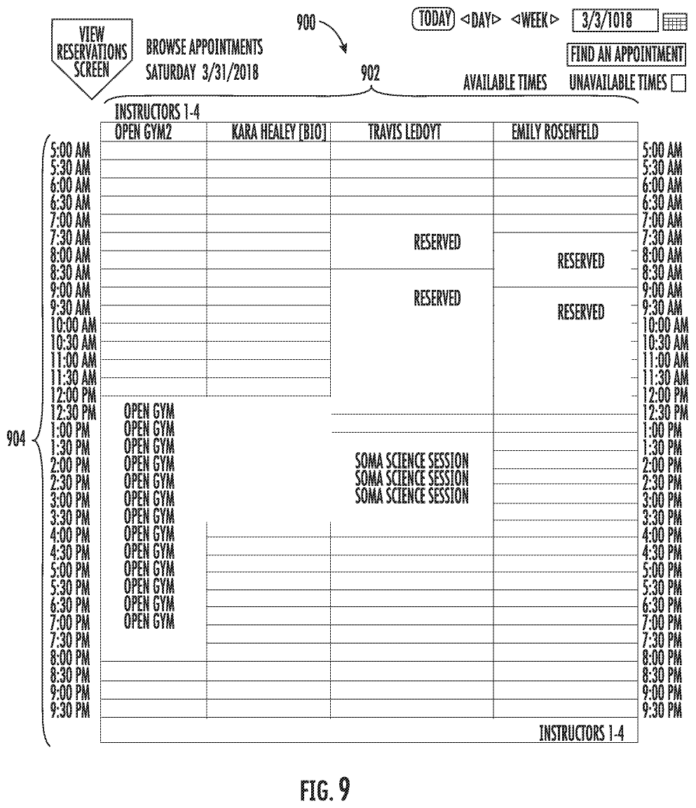

In one embodiment, the storage 106 may include a resource reservation database, containing user credential data that can be matched against the user's credential and/or access code. The resource reservation database may also contain reservation details, including date/time of the reservation, type of reservations, reserving user's identification, and the like. FIG. 9, described further below shows an exemplary resource listing display, showing exemplary reservations made for different resources of the building, facility, and/or secured area 24.

Input component 108 may include a component that permits device 100 to receive information, such as via user input (e.g., a touch screen display, a keyboard, a keypad, a mouse, a button, a switch, a microphone, etc.). Additionally, or alternatively, input component 108 may include a sensor for sensing information (e.g., a global positioning system (GPS) component, an accelerometer, a gyroscope, an actuator, etc.). Output component 110 may include a component that provides output information from device 100 (e.g., a display, a speaker, one or more light-emitting diodes (LEDs), etc.).

Communication component 112 may include a transceiver-like component (e.g., a transceiver, a separate receiver and transmitter, etc.) that enables device 100 to communicate with other devices, such as via a wired connection, a wireless connection, or a combination of wired and wireless connections. Communication component 112 may permit device 100 to receive information from another device and/or provide information to another device. For example, communication component 112 may include an Ethernet interface, an optical interface, a coaxial interface, an infrared interface, a radio frequency (RF) interface, a universal serial bus (USB) interface, a Wi-Fi interface, a cellular network interface, or the like.

Device 100 may perform one or more processes described herein. Device 100 may perform these processes in response to processor 102 executing software instructions stored by a computer-readable medium, such as the memory 104 and/or the storage component 106. A computer-readable medium is defined herein as a non-transitory memory device. A memory device includes memory space within a single physical storage device or memory space spread across multiple physical storage devices.

Software instructions may be read into the memory 104 and/or the storage 106 from another computer-readable medium or from another device via communication component 112. When executed, software instructions stored in the memory 104 and/or the storage 106 may cause processor 102 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 1B are provided as an example. In practice, device 100 may include additional components, fewer components, different components, or differently arranged components than those shown in FIG. 1B. Additionally, or alternatively, a set of components (e.g., one or more components) of device 100 may perform one or more functions described as being performed by another set of components of device 100.

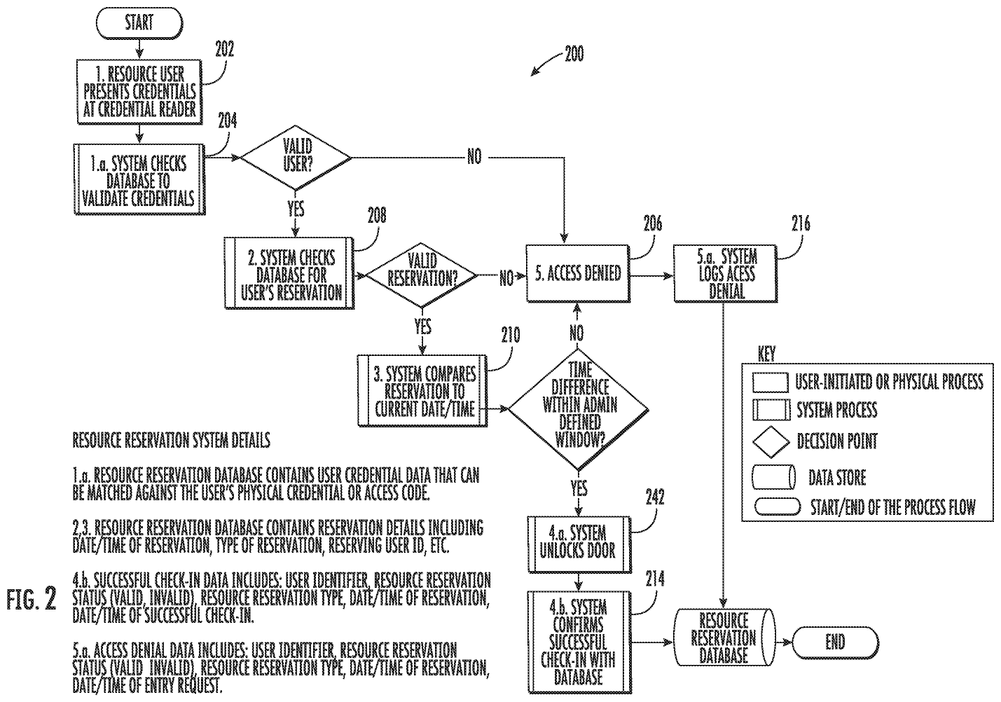

FIG. 2 is a flowchart of an embodiment of an entry system process for an access control system in accordance herewith is shown generally at 200. At step 202, the user 20 presents credentials 22 to the credential reader 14. The credential reader 14 reads the credential 20 and transmits the identification to the server 12. At step 204, the server 12 authenticates the credential 20 the user 22 as valid. If the credential 20 is not for a valid user 22, the user 22 is denied access at step 206. If the credential 20 is valid for the user 22, the server 12 then checks to see whether the user 22 has a valid reservation at step 208. If the user 22 does not have a valid reservation, the user 22 is denied access at step 206. If the user 22 has a valid reservation, the server 12 compares whether the difference in the date and time of the reservation and the current date and/or time are within a permissible window, which may be pre-defined by the administrator or a default value, at step 210. If the difference in time is not within the permissible window, the user 22 is denied access at step 206. If the user 22 is within the permissible window of their reservation, the server 12 then opens or unlocks the access control mechanism 18 at step 212. At step 214, the server 12 then confirms a successful check-in of the user 22 with the storage 106, such as a resource reservation database. If the user 22 has been denied access by the system 10 for any reason at step 206, the server 12 then logs the access denial with the storage 106 at step 216, which may be used for administrative purposes later.

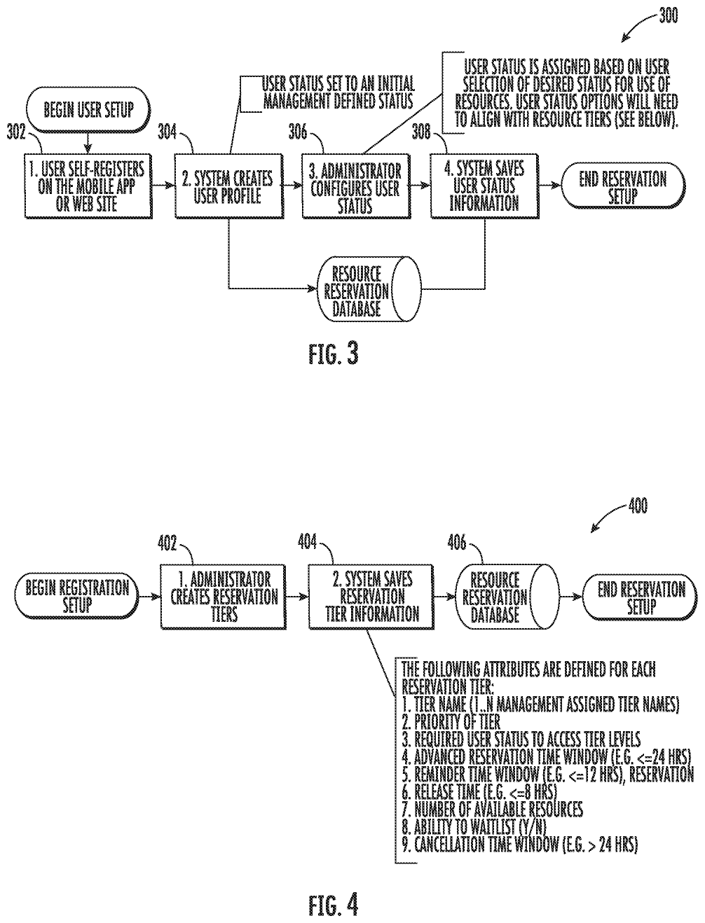

FIG. 3 is a flowchart of an embodiment of a user setup process for an access control system in accordance herewith is shown generally at 300. At step 302, the user 22 may self-register a user profile on the server 12 using a mobile application on a mobile device or website using a web browser. After the user 22 enters their information, the server 12 creates the user profile in the storage 106, such as resources reservation database, at step 304. The server 12 may set a user status to an initial management defined status at the time of creation of the user profile. At step 306, an administrator may change the user status of the user profile to a desired status for use of resources. User status options may include assigning a user status a predefined resource tier, which affects the user's priority to reserve resources of the facility. At step 308, the server 12 saves the user status information to the user profile in the storage 106.

FIG. 4 is a flowchart of an embodiment of a reservation setup process for an access control system in accordance herewith is shown generally at 400. At step 402, the administrator may create reservation tiers for the resource of highest and best use to lowest possible use. As noted above, reservation tiers are used to align user profiles and reservations based on priority. At step 404, the server 12 saves the reservation tier information to the storage 106. A reservation tier may include predefined attributes, such as a tier name, priority of the tier, required user status to access the tier, whether advanced reservation time window is required, a reminder time window, a release time window (when the reservation is automatically canceled by the server 12), number of available resources within the tier, whether the reservation tier includes wait listing, and minimum allowed cancellation window.

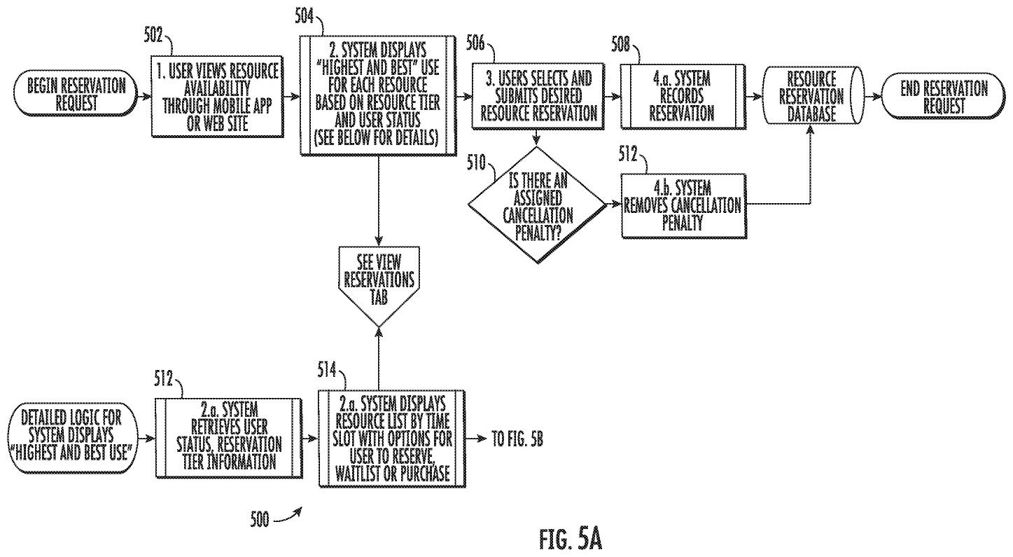

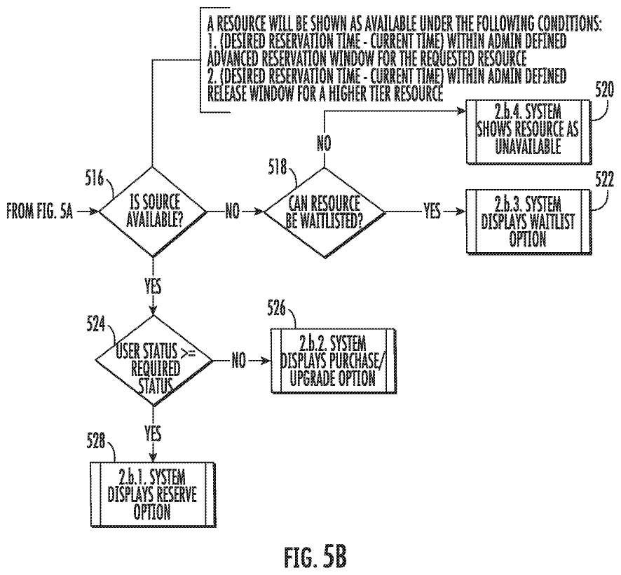

FIG. 5 is a flowchart of an embodiment of a reservation request process for an access control system in accordance herewith is shown generally at 500. At step 502, the user 22 views a resource availability through a user device, such as a mobile device or computer. At step 504, the server 12 displays, via an output component 110 or transmits to a display of a user device via the communication component 112, a “highest and best” use for each resource tier based on the resource tier and user status in a View Reservations Tab of the user device (which will be described in greater detail below). At step 506, the user 22 selects and submits a reservation for a desired resource. At step 508, the server 12 records the reservation in the storage 106. Additionally, at step 510, the server determines whether there is an assigned cancellation penalty (such as for a cancellation by a user 22 outside of the eligible cancellation window for the resource) for the desired resource. If so, the server 12 removes the cancellation penalty at step 512, because the resource has been successfully assigned to a new user.

In determining a “highest and best use” for any given resource, the server 12 may perform one or more of the following steps. At step 512, the server 12 retrieves the user status and reservation tier information for the user profile. At step 514, the server 12 displays, via an output component 110 or transmits to a user device via the communication component 112, an available resource list by time slot with options for the user 22 to reserve, waitlist or purchase the resource. In compiling the available resource list, for each resource the server determines the status of each resource. At step 516, the server first determines if a resource is available. A resource will be indicated as available if the resource is not reserved within a predefined advanced reservation window for the resource based on the current time, and within a predefined release window for a higher tier resource base on the current time. If neither condition is true, the server will determine at step 518, whether the resource is capable of being waitlisted. If the resource is determined to be unavailable for wait-listing, the server will show the resource as unavailable at step 520. If the resource is determined to be available for wait-listing, the server will show the resource as available at step 522. On the other hand, if the resource is available within the predefined windows, at step 516, the server will check to see if the user status meets the required reservation tier for reserving the resource at step 524. In one embodiment, the user status must be greater-than-or-equal to the reservation tier in order for the user to be eligible to reserve the resource. If the user status indicates that the user is eligible to reserve the resource, the server 12 displays, via an output component 110 or transmits to a display of a user device via the communication component 112, a reservation option at step 528. If the user status indicates that the user is not eligible to reserve the resource, the server 12 displays, via an output component 110 or transmits to a display of a user device via the communication component 112, an option to purchase/upgrade option for the user 22 to increase their user status to an eligible reservation tier or a one-time purchase option for the desired resource.

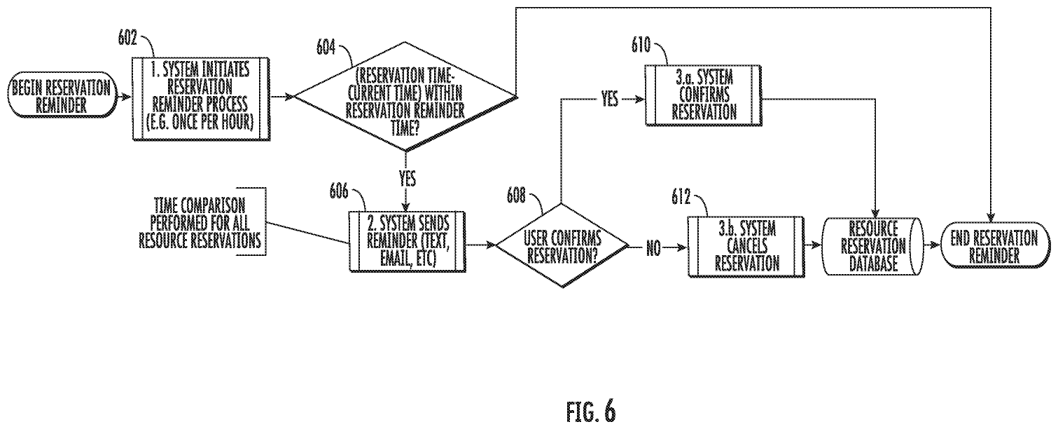

FIG. 6 is a flowchart of an embodiment of a reservation reminder process for an access control system in accordance herewith is shown generally at 600. In step 602, the server 12 initiates a reservation reminder process, which checks all reservations for resources by all users 22 within a predetermined reservation reminder time. The reminder process checks the current time against reservation reminder times for each reservation created in the storage 106 at step 604. If a reservation time is not within the reservation reminder time, the reminder process ends for that reservation. If the reservation time is within the reservation time reminder, however, the server 12 sends a reminder to the user 22 associated with the reservation at step 606. The reminder may include a text, email or automated voice call. At step 608, the reminder process includes a request that the user 22 confirm the reservation. If the user 22 cancels their reservation, the server 12 cancels the reservation for the resource in the storage 106 at step 612. If the user 22 confirms the reservation, the server 12 indicates that the reservation has been confirmed in the storage 106 at step 610.

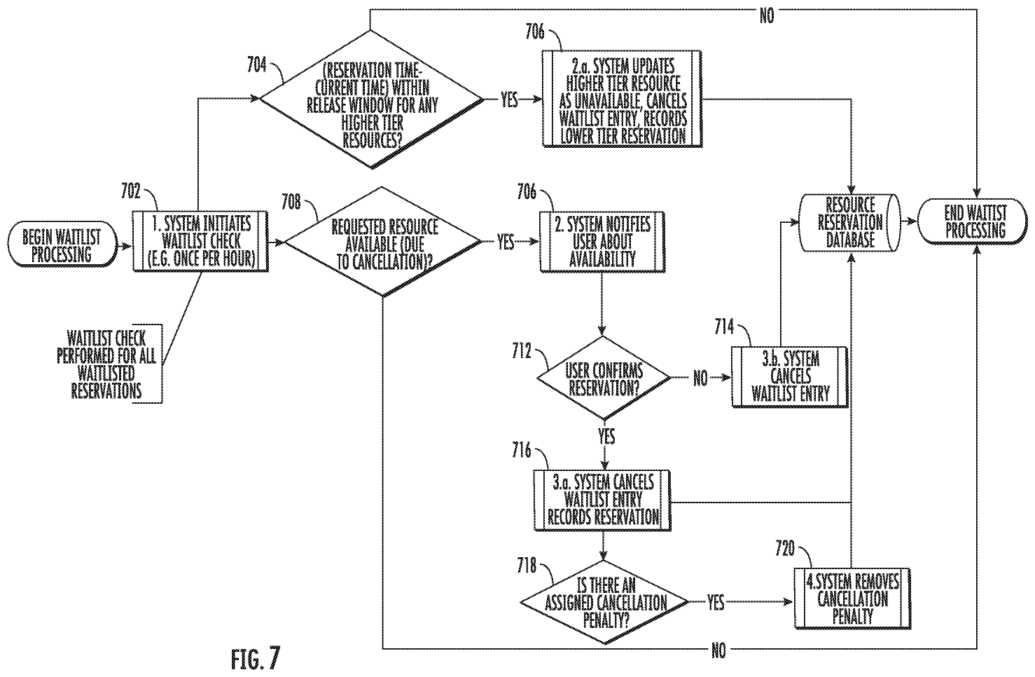

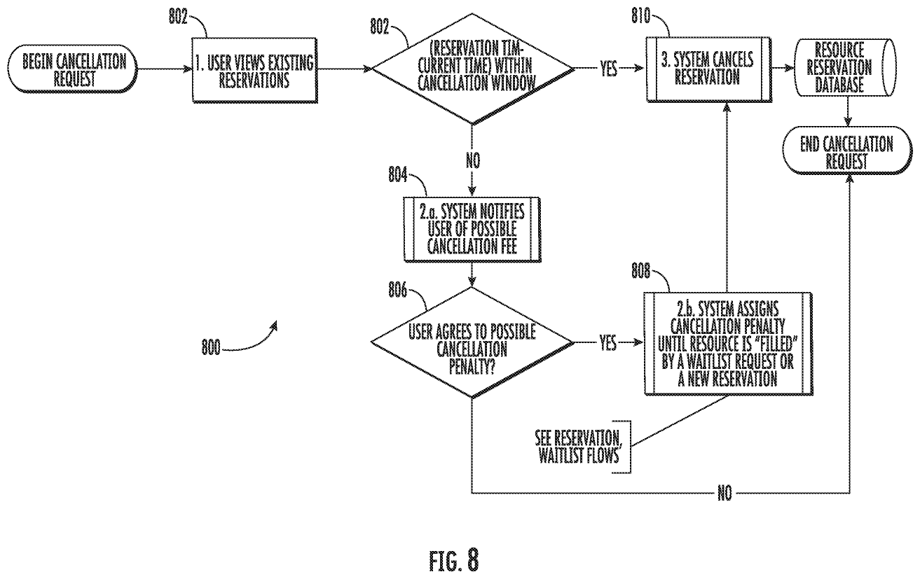

FIG. 7 is a flowchart of an embodiment of a waitlist process for an access control system in accordance herewith is shown generally at 700. At step 702, the server 12 initiates a waitlist check at a predetermined time interval such as, for example, once per hour. The waitlist check is performed for all waitlisted reservations. The server 12 determines if the difference between the reservation time and current time is within a release window for any higher tier resources at step 704. If not, the waitlist check for that resource terminates. If the waitlisted resource is available within the permissible release window, the server 12 updates the higher tier resource as unavailable, cancels the waitlist entry, and records the lower tier waitlist reservation against the resource in the storage 106 at step 706. At step 708, the server 12 checks to see if the requested resource is available due to cancellation. If not, the waitlist process terminates. If the requested resource is available, the server 12 notifies the user 22 about the availability. The notification may be sent via text, email or an automated voice call, via the communication component 112. At step 712, the reminder process includes a request that the user 22 confirm the reservation. If the user 22 cancels their waitlist reservation, the server 12 cancels the waitlist entry for the resource in the storage 106 at step 714. If the user 22 confirms the reservation, the server 12 cancels the user's 22 waitlist entry and indicates that the reservation has been confirmed in the storage 106 at step 716. The server 12 then checks the storage 106 to ascertain whether there is an assigned cancellation penalty associated with the resource at step 718. If there is a cancellation penalty, the server 12 removes the cancellation penalty at step 720 from the user 22 who previously cancelled because the resource has been successfully reassigned to another user.

FIG. 8 is a flowchart of an embodiment of a cancellation request for an access control system in accordance herewith is shown generally at 800. At step 802, the user 22 views existing reservations in their user account through a device 100. At step 802, the server 12 determines, for each reservation, whether the difference in reservation time and current time is within a permissible cancellation window. If not, the server 12 notifies the user 22 of a possible cancellation fee or penalty if the user proceeds with a reservation cancellation request at step 804. If the user 22, at step 806, does not agree to cancellation penalty, the cancellation process ends. If the user 22, at step 806, agrees to the cancellation penalty, the server 12 assigns a cancellation penalty to the user account, until the resource is “filled” by a waitlist request or a new reservation within the permissible reservation window at step 808. If the cancellation request is within the permissible cancellation window at step 802, or the user 22 has agreed to the cancellation penalty and the server 12 has processed the cancellation penalty at steps 806, 808, the server 12 then cancels the reservation at step 810.

FIG. 9 is an illustration of an embodiment of an exemplary resource listing display for a single day for an access control system in accordance herewith is shown generally at 900. The listing display generally includes a number of resources 902 identified at a top row subdivided into available reservations times 904, indicated on the vertical columns. Although the indicated time intervals are half an hour, the time intervals may be more or less granular as desired. For each resource at a specified time, the resource may be indicated as available or unavailable. Resources indicated as unavailable may further indicate the nature of the unavailability, such as a prior reservation or another activity. The resource listing display may extract from the storage 106 by the server 12 and formatted for display on an output component 110 of the server 12 or of a user device. If formatted for display on an output component 110 of a user device the server 12 transmits the resource listing display to the user device via the communication component 112.

Therefore, it can be seen that the access control system described herein solves the problems of the prior art by providing a system that not only can control access to a building, facility or otherwise secured area to authorized users, but also ensures that authorized users have a valid reason to request entry at an appropriate time and that the resources contained within the building, facility or otherwise secured area are offered to users first at their highest and best use and as their expiration time approaches lowering the use of the resource in an attempt to minimize the expiration of the resource without any use by a user.

Those skilled in the art will appreciate that the conception, upon which this disclosure is based, may readily be utilized as a basis for designing other products without departing from the spirit and scope of the invention as defined by the appended claims. Therefore, the claims are not to be limited to the specific examples depicted herein. For example, the features of one example disclosed above can be used with the features of another example. Furthermore, various modifications and rearrangements of the parts may be made without departing from the spirit and scope of the underlying inventive concept. For example, the geometric configurations disclosed herein may be altered depending upon the application, as may the material selection for the components. Thus, the details of these components as set forth in the above-described examples, should not limit the scope of the claims.

What is claimed is:

1. An access control system comprising:
a secured area having an entrance;
a plurality of resources contained within the secured area;
a resource reservation database containing reservations that associate a credential of a user with one or more of the plurality of resources and a reservation time;
an access control mechanism connected to the entrance, the access control mechanism having a locked position that prevents access to the secured area and an unlocked position that allows access to the secured area;
a credential reader configured and arranged to read a credential presented to the credential reader; and
a server connected to the credential reader and access control, the server configured and arranged to determine if the credential presented to the credential reader matches the credential of one or more of the reservations in the resource reservation database;
wherein the server is configured and arranged to unlock the access control mechanism if the credential presented to the credential reader matches the credential of one or more of the reservations in the reservation database.

2. The system of claim 1, wherein the server is further configured and arranged to calculate a difference between a time that the credential is presented and the time of one or more of the reservations and compare the difference to a permissible time window to validate whether a user is within the permissible time window of the reservation.

3. The system of claim 1, wherein the server is further configured and arranged to receive a reservation request from a user for a resource at a desired date and time and, if available, reserve the resource for the user at the desired date and time.

4. The system of claim 3, wherein the server is further configured and arranged to compare a user status with a reservation tier of the desired resource prior to confirming the reservation.

5. The system of claim 4, wherein the server is configured and arranged to offer a purchase/upgrade option to a user having an insufficient user status.

6. The system of claim 3, wherein the server is configured and arranged to offer to waitlist a user for a resource if the resource is unavailable at the desired date and time.

7. The system of claim 1, wherein the credential comprises a mobile device.

8. The system of claim 1, wherein the entrance is a door.

9. The system of claim 1, wherein the credential reader is configured and arranged to communicate with a mobile device.

10. The system of claim 1, wherein the server comprises a storage having a database.

11. A method of controlling access to secured area having an entrance secured with an access control mechanism having a locked position and an unlocked position, the method comprising:
creating one or more reservations that associates a credential of a user with one or more resources located within the secured area;
reading a credential presented by a user requesting access the secured area with a credential reader;
transmitting information read by the credential reader to a server;
with the server, comparing the credential presented by the user to one or more reservations to determine if the user has a reservation for at least one of the one or more resources within the secured area; and
if the user has a reservation, operating the access control mechanism to the unlocked position thereby allowing the user to enter the secured area.

12. The method of claim 11, further comprising calculating a difference between a time that the credential is presented and the time of one or more of the reservations and compare the difference to a permissible time window to validate whether a user is within the permissible time window of the reservation.

13. The method of claim 11, further comprising receiving a reservation request from a user for a resource at a desired date and time and, if available, reserving the resource for the user at the desired date and time.

14. The method of claim 13, further comprising comparing a user status with a reservation tier of the desired resource prior to confirming the reservation.

15. The method of claim 14, further comprising offering a purchase/upgrade option to a user having an insufficient user status.

16. The method of claim 13, further comprising offering to waitlist a user for a resource if the resource is unavailable at the desired date and time.

17. The method of claim 11, further comprising assessing a penalty to a user for cancelling a reservation outside of a permissible time window or missing a reservation.

18. An access control system for secured area having an entrance and containing a plurality of resources, the system comprising:
a resource reservation database containing reservations that associate a credential of a user with one or more of the plurality of resources and a reservation time;
an access control mechanism connected to the entrance, the access control mechanism operable between a locked position and an unlocked position;
a credential reader configured and arranged to read a credential presented to the credential reader; and
a device communicatively connected to the credential reader, the device configured and arranged to determine if the credential presented to the credential reader matches the credential of one or more reservations in the resource reservation database;
wherein the access control mechanism is operated to the unlocked position if the credential presented to the credential reader matches the credential of one or more reservations in the resource reservation database.

19. The system of claim 18, wherein the device is further configured and arranged to calculate a difference between a time that the credential is presented and the time of one or more of the reservations and compare the difference to a permissible time window to validate whether a user is within a permissible time window of the reservation.

20. The system of claim 18, wherein the device is further configured and arranged to receive a reservation request from a user for a resource at a desired date and time and, if available, reserve the resource for the user at the desired date and time.
